(19) United States
(12) Patent Application Publication
(10) Pub. No.: US 2014/0152877 A1
(43) Pub. Date: Jun. 5, 2014

(54) IMAGING APPARATUS

(71) Applicant: PANASONIC CORPORATION, Osaka (JP)

(72) Inventor: Hironori HONSHO, Hyogo (JP)

(73) Assignee: PANASONIC CORPORATION, Osaka (JP)

(21) Appl. No.: 14/172,588

(22) Filed: Feb. 4, 2014

Related U.S. Application Data
(63) Continuation of application No. PCT/JP2013/000124, filed on Jan. 15, 2013.

(30) Foreign Application Priority Data
Jan. 19, 2012 (JP) 2012-008871

(51) Int. Cl. H04N 5/262; H04N 5/225

(52) U.S. Cl. CPC H04N 5/262; H04N 5/2252
USPC 348/239

(57) ABSTRACT

An imaging apparatus (100) includes an outer shell (1), a camera body (2) configured to move in the outer shell (1) and shoot an image of an object outside the outer shell (1) through the outer shell (1), an obstruction detector (71) configured to detect an obstruction in or on the outer shell (1) from the image shot by the camera body (2), and an obstruction remover (73) configured to remove an image of the obstruction detected by the obstruction detector (71) from the shot image.

### CROSS-REFERENCE TO RELATED APPLICATIONS

This is a continuation of International Application No. PCT/JP2013/000124 filed on Jan. 15, 2013, which claims priority to Japanese Patent Application No. 2012-008871 filed on Jan. 19, 2012. The entire disclosures of these applications are incorporated by reference herein.

### BACKGROUND

The technique disclosed herein relates to an imaging apparatus including an imager arranged inside a case having a spherical inner surface.

In an imaging apparatus described in Japanese Patent Publication No. H09-254838, an imager is arranged inside an outer shell having a spherical inner surface. The outer shell is divided into two parts. Such two parts are joined together in the state in which the imager is accommodated inside the two parts. In the imaging apparatus, the imager moves relative to the inner surface of the outer shell. This allows shooting while adjusting an imaging range. More specifically, the imager includes three drive wheels, and the drive wheels contact the inner surface of the outer shell. In such a manner that the drive wheels are driven, the imager moves along the inner surface of the outer shell. The imager shoots, through the outer shell, an image of an object outside the outer shell.

### SUMMARY

However, in the imaging apparatus described in Japanese Patent Publication No. H09-254838, there is a possibility that, if there is an obstruction on or near the outer shell, an image quality is degraded due to, e.g., unexpected appearance of the obstruction in a shot image. Examples of the obstruction include a joint part of the outer shell and dust adhered to the outer shell.

The technique disclosed herein has been made in view of the foregoing, and is directed to reduce degradation of an image quality due to an obstruction on or near an outer shell.

The technique disclosed herein is directed to an imaging apparatus for shooting an object image. The imaging apparatus includes a case; an imager configured to move in the case and shoot an image of an object outside the case through the case; an obstruction detector configured to detect an obstruction in or on the case from the image shot by the imager; and an image processor configured to remove an image of the obstruction detected by the obstruction detector from the image shot by the imager. The obstruction “in” the case means an obstructing object contained in the case itself. Note that the obstructing object is not positioned in an inner space of the case. The obstruction “on” the case means an obstructing object on an inner surface or an outer surface of the case.

According to the technique disclosed herein, degradation of the image quality due to the obstruction in, on, or near the outer shell can be reduced.

### BRIEF DESCRIPTION OF THE DRAWINGS

FIG. 1 is a perspective view of an imaging apparatus.

FIGS. 2A and 2B are cross-sectional views of the imaging apparatus. FIG. 2A is the cross-sectional view of the imaging apparatus along a plane passing through the center of an outer shell and being perpendicular to a P axis. FIG. 2B is the cross-sectional view of the imaging apparatus along a B-B line illustrated in FIG. 2A.

FIGS. 3A and 3B illustrate a camera body. FIG. 3A is a perspective view of the camera body. FIG. 3B is a front view of the camera body.

FIG. 4 is an exploded perspective view of a movable frame and first to third drivers.

FIG. 5 is a functional block diagram of the imaging apparatus.

FIGS. 6A and 6B are arrangement views of photo sensors in the outer shell. FIG. 6A is the view of the photo sensors from the back in an optical axis direction. FIG. 6B is the view of the photo sensors in a direction perpendicular to the optical axis direction.

FIGS. 7A, 7B, and 7C are graphs each showing the distance from the center of the outer shell to a surface of a reflective film. FIG. 7A is the graph for a first cut plane 51 which is coincident with a joint part. FIG. 7B is the graph for a second cut plane S2 which is apart from the joint part by a first distance. FIG. 7C is the graph for a third cut plane S3 which is apart from the joint part by a second distance longer than the first distance.

FIG. 8 is a graph showing an output of the photo sensor in association with the angular position thereof.

FIG. 9 is a functional block diagram illustrating a section provided in an image processor and configured to perform obstruction removal processing.

FIG. 10 is a view illustrating the situation in which the joint part is within a shooting range of the camera body upon shooting of an object image.

FIGS. 11A, 11B, and 11C illustrate a shot image in the course of obstruction removal processing.

FIG. 12 is a view illustrating a usage example of the imaging apparatus.

FIG. 13 is a cross-sectional view of an imaging apparatus of a variation.

FIGS. 14A, 14B, and 14C illustrate a camera body of the variation. FIG. 14A is a perspective view of the camera body. FIG. 14B is a right side view of the camera body.

FIG. 14C is a perspective view from an angle different from that of FIG. 14A.

FIG. 15 is a functional block diagram of a lens barrel and an image processor of a second embodiment.

### DETAILED DESCRIPTION

An embodiment is described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventor(s) provides the following description and the attached drawings to enable those skilled in the art to fully understand the present disclosure. Thus, the description and the drawings are not intended to limit the scope of the subject matter defined in the claims.

<1. External Appearance>

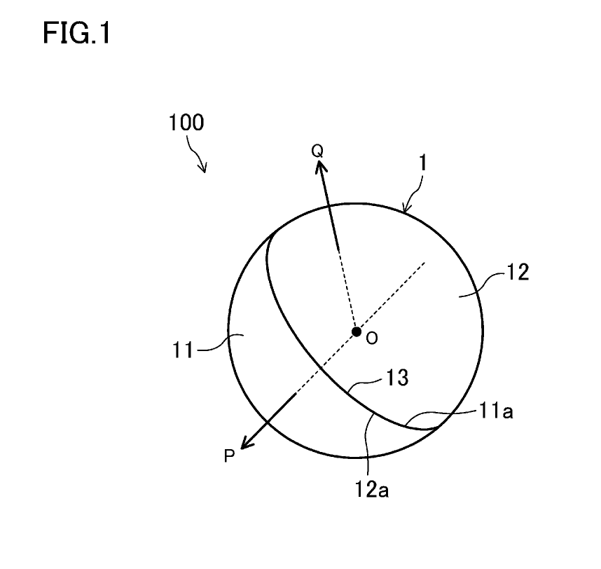

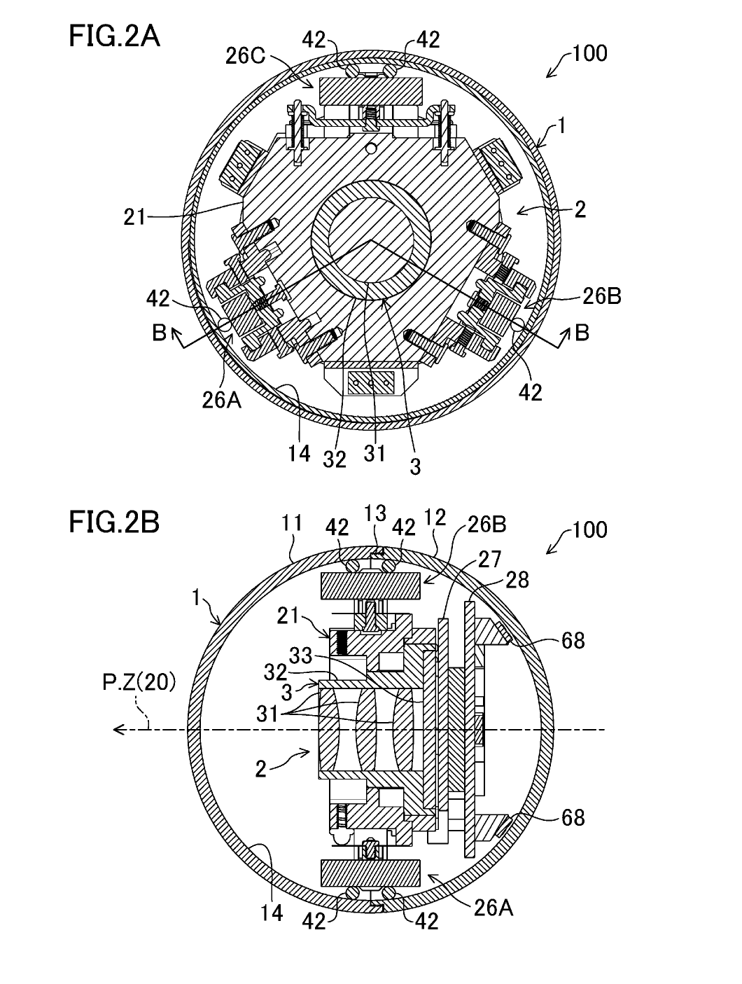

FIG. 1 is a perspective view of an imaging apparatus 100. FIGS. 2A and 2B are cross-sectional views of the imaging apparatus 100. FIG. 2A is the cross-sectional view of the imaging apparatus 100 along a plane passing through the center O of an outer shell 1 and being perpendicular to a P axis, and FIG. 2B is the cross-sectional view of the imaging apparatus 100 along a B-B line illustrated in FIG. 2A.

The imaging apparatus 100 includes the substantially spherical outer shell 1 and a camera body 2 arranged inside the outer shell 1. The camera body 2 moves relative to the outer shell 1 along an inner surface of the outer shell 1. While moving inside the outer shell 1, the camera body 2 shoots, through the outer shell 1, an image of an object outside the outer shell 1.

<2. Outer Shell>

The outer shell 1 includes a first case 11 and a second case 12. The first case 11 and the second case 12 are joined together, thereby forming a substantially spherical shape. The outer shell 1 has a substantially spherical inner surface. The outer shell 1 is one example of a case. The first case 11 is one example of a first part. The second case 12 is one example of a second part.

The first case 11 is formed in a spherical-sector shape. The “spherical sector” means a “spherical zone” formed with only one opening. An opening 11a of the first case 11 forms the great circle of the outer shell 1. That is, the first case 11 is formed in a hemispherical shape. The first case 11 is formed so as to have an inner spherical sector surface. The first case 11 is made of a high hardness material (e.g., a glass material or a ceramics material) transparent to visible light. The high hardness material reduces abrasion due to contact with a driver element 42 which will be described later.

The second case 12 is formed in a spherical-sector shape. An opening 12a of the second case 12 forms the great circle of the outer shell 1. That is, the second case 12 is formed in a hemispherical shape. The second case 12 is formed so as to have an inner spherical sector surface. The inner surface of the second case 12 has the substantially same curvature as that of the inner surface of the first case 11. The second case 12 is made of a high hardness material (e.g., a glass material or a ceramics material) transparent to visible light. The high hardness material reduces abrasion due to contact with the driver element 42 which will be described later.

The first case 11 and the second case 12 are joined together at the opening 11a and the opening 12a. In such a manner, the outer shell 1 having a joint part 13 is formed.

On the inner surface of the outer shell 1, i.e., the inner surfaces of the first and second cases 11, 12, a reflective film 14 is formed such that visible light can pass through the reflective film 14 and that infrared light having a wavelength of about 900 nm can be reflected by the reflective film 14. The configuration of the reflective film 14 will be described in detail later.

Referring to FIG. 1, the center point (i.e., the center of the first case 11) of the outer shell 1 is defined as an “O point,” a straight line passing through the O point and the center of the opening 11a of the first case 11 is defined as a “P axis,” and an axis passing through the O point so as to be perpendicular to the P axis is defined as a “Q axis.”

<3. Camera Body>

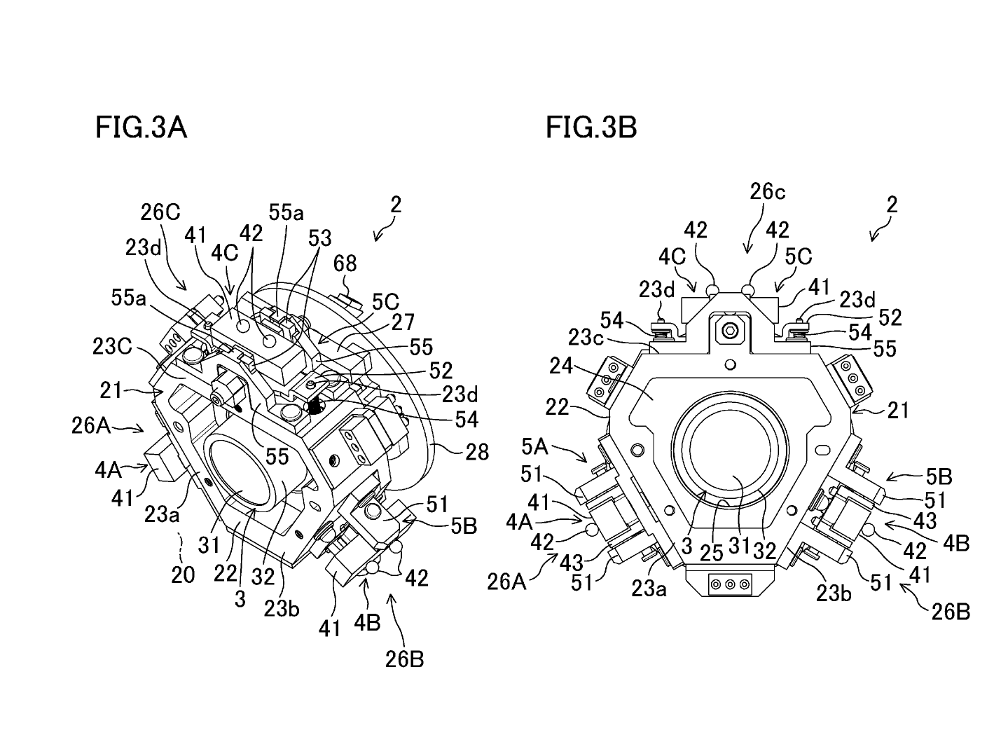

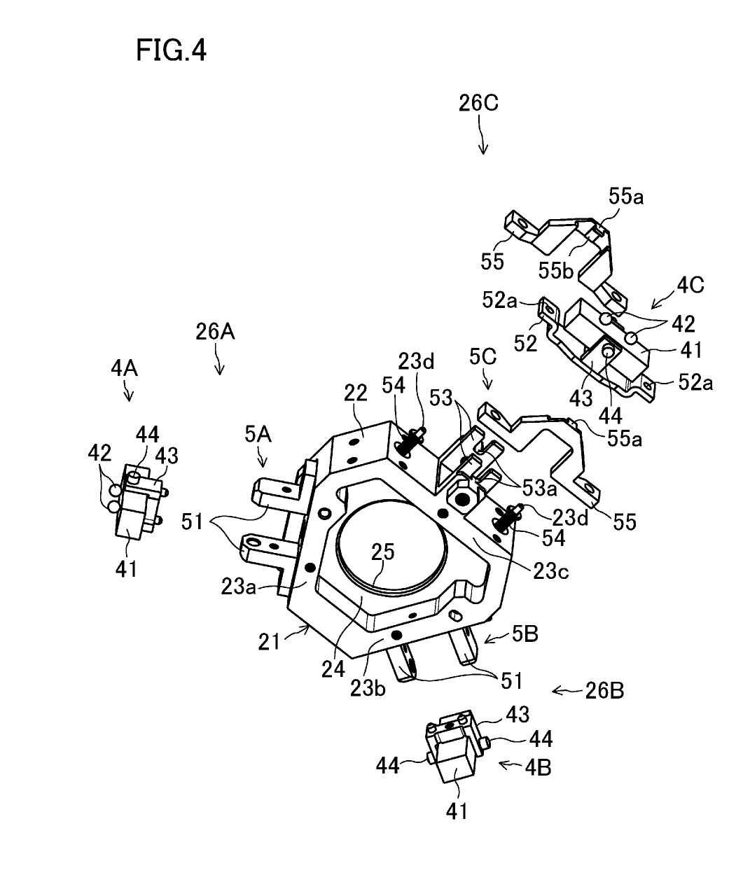

FIGS. 3A and 3B illustrate the camera body 2. FIG. 3A is a perspective view of the camera body 2, and FIG. 3B is a front view of the camera body 2. FIG. 4 is an exploded perspective view of a movable frame 21 and first to third drivers 26A-26C.

The camera body 2 includes the movable frame 21, a lens barrel 3, the first to third drivers 26A-26C attached to the movable frame 21, an attachment plate 27 configured to attach the lens barrel 3 to the movable frame 21, and a circuit board 28 configured to control the camera body 2. The camera body 2 can shoot still images and moving pictures. An optical axis 20 of the lens barrel 3 is referred to as a “Z axis,” and a side close to an object relative to the optical axis 20 is a front side. The camera body 2 is one example of an imager.

The movable frame 21 is a substantially equilateral-triangular frame body as viewed from the front. The movable frame 21 includes an outer peripheral wall 22 which has first to third side walls 23a-23c forming three sides of the triangle, and a dividing wall 24 formed inside the outer peripheral wall 22. An opening 25 is formed at the center of the dividing wall 24.

The lens barrel 3 includes a plurality of lenses 31 having the optical axis 20, a lens frame 32 configured to hold the lenses 31, and an imaging device 33. The lens frame 32 is arranged inside the movable frame 21, and the optical axis 20 passes through the center of the movable frame 21. The attachment plate 27 is provided on a back side of the imaging device 33 of the lens barrel 3 (see FIG. 2B). The lens barrel 3 is attached to the movable frame 21 through the attachment plate 27. The circuit board 28 is attached to the attachment plate 27 on a side opposite to the lens barrel 3.

The first to third drivers 26A-26C are provided on an outer circumferential surface of the movable frame 21. Specifically, the first driver 26A is provided on the first side wall 23a. The second driver 26B is provided on the second side wall 23b. The third driver 26C is provided on the third side wall 23c. The first to third drivers 26A-26C are arranged about the Z axis at substantially equal intervals, i.e., at about every 120°. Referring to FIG. 3B, an axis passing through the third driver 26C so as to be perpendicular to the Z axis is referred to as a “Y axis,” and an axis perpendicular to both of the Z and Y axes is referred to as an “X axis.”

The first driver 26A includes an actuator body 4A and a first support mechanism 5A. The second driver 26B includes an actuator body 4B and a second support mechanism 5B. The third driver 26C includes an actuator body 4C and a third support mechanism 5C.

The actuator bodies 4A-4C have the same configuration. Only the actuator body 4A will be described below, and the description of the actuator bodies 4B, 4C will not be repeated. The actuator body 4A includes an oscillator 41, two driver elements 42 attached to the oscillator 41, and a holder 43 configured to hold the oscillator 41.

The oscillator 41 is a piezoelectric device made of multilayer ceramic. The oscillator 41 is formed in a substantially rectangular parallelepiped shape. In such a manner that predetermined drive voltage (alternating voltage) is applied to an electrode (not shown in the figure) of the oscillator 41, the oscillator 41 harmonically generates stretching vibration in a longitudinal direction of the oscillator 41 and bending vibration in a transverse direction of the oscillator 41.

The driver elements 42 are, on one side surface of the oscillator 41, arranged in the longitudinal direction of the oscillator 41. The driver element 42 is a ceramic spherical body, and is bonded to the oscillator 41. The stretching vibration and the bending vibration of the oscillator 41 generates elliptic motion of each of the driver elements 42. By the elliptic motion of the driver elements 42, drive force in the longitudinal direction of the oscillator 41 is output.

The holder 43 is made of polycarbonate resin containing glass. The holder 43 sandwiches the oscillator 41 from both sides in a layer stacking direction (i.e., a direction perpendicular to both of the longitudinal and transverse directions) of the oscillator 41. The holder 43 is bonded to the oscillator 41. In the holder 43, a rotary shaft 44 extending in the layer stacking direction of the oscillator 41 is provided so as to outwardly protrude.

The first support mechanism 5A includes two L-shaped brackets 51. The brackets 51 are screwed to an outer surface of the first side wall 23a. The brackets 51 rotatably support the rotary shaft 44 of the holder 43 with the actuator body 4A being sandwiched between the brackets 51. Thus, the actuator body 4A is supported by the first support mechanism 5A so as to rotate about an axis which is parallel to a plane perpendicular to the Z axis and which is parallel to the first side wall 23a. In such a state, the driver elements 42 of the actuator body 4A are arranged parallel to the Z axis.

The second support mechanism 5B has a configuration similar to that of the first support mechanism 5A, and includes two L-shaped brackets 51. The brackets 51 are screwed to an outer surface of the second side wall 23b. The brackets 51 rotatably support the rotary shaft 44 of the holder 43 with the actuator body 4B being sandwiched between the brackets 51. Thus, the actuator body 4B is supported by the second support mechanism 5B so as to rotate about the axis which is parallel to the plane perpendicular to the Z axis and which is parallel to the second side wall 23b. In such a state, the driver elements 42 of the actuator body 4B are arranged parallel to the Z axis.

The third support mechanism 5C includes a holding plate 52 attached to the holder 43, two supports 53 configured to support the rotary shaft 44 of the actuator body 4C, two biasing springs 54, and stoppers 55 configured to restrict movement of the rotary shaft 44. The holding plate 52 is screwed to the holder 43. The holding plate 52 is a plate-shaped member extending in the longitudinal direction of the oscillator 41, and an opening 52a is formed in each end part of the holding plate 52. A tip end of a pin 23d which will be described later is inserted into the opening 52a. The supports 53 are arranged parallel to a Z-axis direction on the third side wall 23c. A guide groove 53a engaged with the rotary shaft 44 is formed at a tip end of the support 53. The guide groove 53a extends in a direction perpendicular to the Z axis. The rotary shaft 44 of the holder 43 is fitted into the guide grooves 53a so as to move back and forth in a longitudinal direction of the guide groove 53a and to rotate about an axis of the rotary shaft 44. Each tip end of the rotary shaft 44 protrudes beyond the support 53 in the Z-axis direction. Two pins 23d are provided on an outer surface of the third side wall 23c. The biasing spring 54 is fitted onto the pin 23d. The stopper 55 includes a first restrictor 55a configured to restrict movement of the rotary shaft 44 in the longitudinal direction (i.e., a direction in which the guide groove 53a extends) of the guide groove 53a, and a second restrictor 55b configured to restrict movement of the rotary shaft 44 in a direction parallel to the Z axis. The stoppers 55 are screwed to the third side wall 23c. In the state in which the stoppers 55 are attached to the third side wall 23c, each of the first restrictors 55a is fitted into a tip end of the guide groove 53a (see FIG. 3A). In the state in which the stoppers 55 are attached to the third side wall 23c, each of the second restrictors 55b is arranged at a position facing the tip end of the rotary shaft 44 engaged with the guide grooves 53a.

In the third support mechanism 5C configured as described above, the actuator body 4C is mounted in the supports 53 such that the rotary shaft 44 of the holder 43 is fitted into the guide grooves 53a. The holding plate 52 and the third side wall 23c sandwich the biasing springs 54, thereby compressing and deforming the biasing springs 54. In such a state, the stoppers 55 are screwed to the third side wall 23c. The actuator body 4C is, by elastic force of the biasing springs 54, biased toward a side apart from the Z axis in the direction perpendicular to the Z axis. Since each of the tip ends of the guide grooves 53a is closed by the first restrictor 55a of the stopper 55, the rotary shaft 44 is prevented from being detached from the guide grooves 53a. Moreover, since each of the second restrictors 55b of the stoppers 55 is arranged at the position facing the tip end of the rotary shaft 44, movement of the actuator body 4C in the Z-axis direction is restricted by the second restrictors 55b. That is, the actuator body 4C is supported by the third support mechanism 5C so as to move in the longitudinal direction of the guide groove 53a and to rotate about the rotary shaft 44. As in the foregoing, the actuator body 4C is supported by the third support mechanism 5C so as to be rotatable about an axis parallel to the Z axis. In such a state, the driver elements 42 of the actuator body 4C are arranged in a circumferential direction about the Z axis.

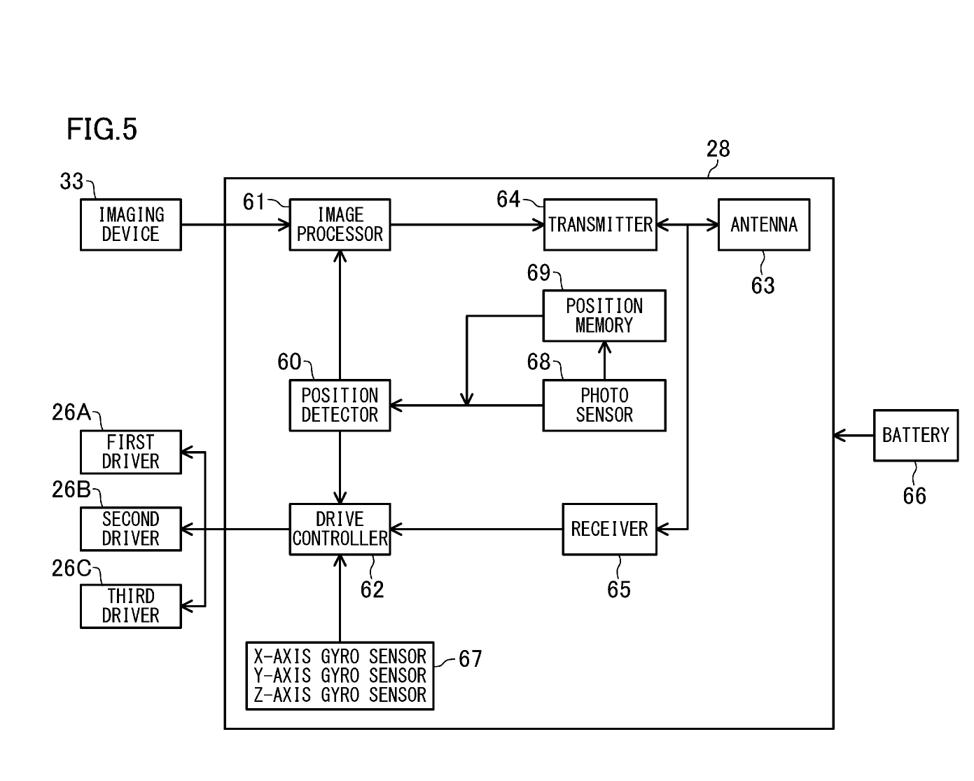

FIG. 5 is a functional block diagram of the imaging apparatus 100. The circuit board 28 includes an image processor 61 configured to perform video signal processing based on an output signal from the imaging device 33, a drive controller 62 configured to control driving of the first to third drivers 26A-26C, an antenna 63 configured to transmit/receive a wireless signal, a transmitter 64 configured to convert a signal from the image processor 61 into a transmission signal to transmit the transmission signal through the antenna 63, a receiver 65 configured to receive a wireless signal through the antenna 63 and to convert the wireless signal to output the converted signal to the drive controller 62, a battery 66 configured to supply power to each section of the circuit board 28, a gyro sensor 67 configured to detect the angular velocity of the camera body 2, three photo sensors 68 configured to detect the position of the camera body 2, a position memory 69 configured to store a correspondence relationship among outputs of the photo sensors 68 and the position of the camera body 2, and a position detector 60 configured to detect the position of the camera body 2 based on outputs of the photo sensors 68 and the correspondence relationship stored in the position memory 69.

The gyro sensor 67 is for three detection axes. That is, the gyro sensor 67 is a sensor package including an X-axis gyro sensor configured to detect a rotation angular velocity about the X axis, a Y-axis gyro sensor configured to detect a rotation angular velocity about the Y axis, and a Z-axis gyro sensor configured to detect a rotation angular velocity about the Z axis. The gyro sensor 67 is configured to output a signal corresponding to an angular velocity about each of the detection axes. Rotational movement of the camera body 2 can be detected based on an output signal of the gyro sensor 67.

The photo sensor 68 includes a light emitter (not shown in the figure) configured to output infrared light, and a light receiver (not shown in the figure) configured to receive infrared light. The photo sensor 68 is configured to emit/receive infrared light having a wavelength of 900 nm. Since an IR cut filter is provided in the front of the imaging device 33, unexpected appearance of unnecessary light in a shot image due to infrared light from the photo sensors 68 can be reduced or prevented. The photo sensors 68 are, at different positions, arranged on a surface of the circuit board 28 opposite to the movable frame 21. Each of the photo sensors 68 is arranged so as to output infrared light toward the inner surface of the outer shell 1 and to receive light reflected by the reflective film 14 formed on the inner surface of the outer shell 1.

The image processor 61 is configured to perform, e.g., amplification and A/D conversion of an output signal of the imaging device 33, and image processing of a shot image. The drive controller 62 is configured to output drive voltage (i.e., a control signal) to each of the first to third drivers 26A-26C. The drive controller 62 generates drive voltage based on a signal (command) input from the outside through the antenna 63 and the receiver 65, an output signal of the gyro sensor 67, and output signals of the photo sensors 68. The position detector 60 is configured to detect the position of the camera body 2 based on outputs of the photo sensors 68 and information stored in the position memory 69 to output such position information to the image processor 61 and the drive controller 62.

<4. Arrangement of Camera Body Inside Outer Shell>

Referring to FIGS. 2A and 2B, the camera body 2 is arranged inside the outer shell 1. The state in which the Z axis of the camera body 2 and the P axis of the outer shell 1 are coincident with each other is referred to as a “reference state.” That is, FIGS. 2A and 2B illustrate the reference state of the imaging apparatus 100. Each of the driver elements 42 of the first to third drivers 26A-26C contacts the inner surface of the outer shell 1. The lens barrel 3 faces the first case 11 in the reference state. In the reference state, the circuit board 28 is positioned inside the second case 12. The third driver 26C is movable in a radial direction about the Z axis, and is biased toward the outside in the radial direction by the biasing springs 54. Thus, the driver elements 42 of the third driver 26C contact the inner surface of the outer shell 1 in the state in which the driver elements 42 are pressed against the inner surface of the outer shell 1 by elastic force of the biasing springs 54. The driver elements 42 of the first and second drivers 26A, 26B contact the inner surface of the outer shell 1 in the state in which the driver elements 42 are pressed against the inner surface of the outer shell 1 by reactive force of the biasing springs 54. In the reference state, the driver elements 42 of the first driver 26A are arranged parallel to the P axis. The driver elements 42 of the second driver 26B are arranged parallel to the P axis. On the other hand, the driver elements 42 of the third driver 26C are arranged in a circumferential direction of the great circle of the outer shell 1, i.e., in a circumferential direction about the P axis. The actuator body 4C of the third driver 26C is movable in the radial direction about the Z axis, and each of the actuator bodies 4A-4C of the first to third drivers 26A-26C is supported so as to rotate about the rotary shaft 44. Thus, e.g., a shape error of the inner surface of the outer shell 1 and an assembly error of each of the drivers are absorbed.

<5. Operation of Camera Body>

When drive voltage is applied to the first to third drivers 26A-26C, elliptic motion of each of the driver elements 42 of the first to third drivers 26A-26C is generated. Upon the elliptic motion of the driver elements 42, the first driver 26A outputs drive force in the direction parallel to the Z axis. The second driver 26B outputs drive force in the direction parallel to the Z axis. The third driver 26C outputs drive force in the circumferential direction about the Z axis. Thus, the drive force of the first driver 26A and the drive force of the second driver 26B can be combined together, thereby arbitrarily adjusting the inclination of the Z axis of the camera body 2 relative to the P axis of the outer shell 1. Moreover, the camera body 2 can rotate about the Z axis by the drive force of the third driver 26C. As in the foregoing, in such a manner that the drive force of the first to third drivers 26A-26C is adjusted, the camera body 2 can rotationally move relative to the outer shell 1, and the attitude of the camera body 2 on the outer shell 1 can be arbitrarily adjusted.

A basic drive control of the camera body 2 will be described below.

The camera body 2 is driven according to a manual command from the outside and a correction command based on an output of the gyro sensor 67.

Specifically, when a manual command is input from the outside through wireless communication, the drive controller 62 generates manual drive command values based on the manual command. The manual command is, e.g., a command to follow a particular object or a command to perform panning (i.e., rotation about the Y axis), tilting (i.e., rotation about the X axis), or rolling (i.e., rotation about the Z axis) of the camera body 2 at a predetermined angle. Each manual drive command value is a command value for a corresponding one of the first to third drivers 26A-26C. The drive controller 62 applies drive voltage corresponding to the manual drive command value to each of the first to third drivers 26A-26C. As a result, the first to third drivers 26A-26C are operated, and therefore the camera body 2 moves according to the manual command.

If disturbance acts on the camera body 2, the gyro sensor 67 outputs a detection signal of the disturbance to the drive controller 62. The drive controller 62 generates, based on an output of the gyro sensor 67, a command value for canceling rotation of the camera body 2 due to disturbance. Specifically, the drive controller 62 generates, based on a detection signal of the gyro sensor 67, a command value (hereinafter referred to as an “X-axis gyro command value”) for rotation about the X axis, a command value (hereinafter referred to as a “Y-axis gyro command value”) for rotation about the Y axis, and a command value (hereinafter referred to as a “Z-axis gyro command value) for rotation about the Z axis such that rotation about the X, Y, and Z axes of the camera body 2 is canceled. The X-axis gyro command value and the Y-axis gyro command value are synthesized at a predetermined rate, thereby generating a gyro drive command value to be output to the first driver 26A. Moreover, the X-axis gyro command value and the Y-axis gyro command value are synthesized at a predetermined rate, thereby generating a gyro drive command value to be output to the second driver 26B. The Z-axis gyro command value is output to the third driver 26C as a gyro drive command value. The drive controller 62 applies drive voltage corresponding to each gyro drive command value to a corresponding one of the first to third drivers 26A-26C. As a result, the first to third drivers 26A-26C are operated, and the camera body 2 moves such that disturbance acting on the camera body 2 is canceled. Thus, the attitude of the camera body 2, i.e., the direction of the optical axis 20, is maintained constant.

If a manual command is input and disturbance acts on the camera body 2, manual drive command values and gyro drive command values are simultaneously generated. Then, all values are synthesized to generate final drive command values.

Since shaking of the camera body 2 upon rotation thereof is, regardless of presence/absence of the manual command, reduced based on an output of the gyro sensor 67, blurring of a shot image is reduced. Moreover, the image processor 61 detects a motion vector of a moving picture and performs, by image processing, electronic correction of an image blur based on the motion vector. That is, in the imaging apparatus 100, a relatively-large image blur with a low frequency is reduced by controlling the attitude of the camera body 2, and a relatively-small image blur with a high frequency is corrected by electronic correction of the image processor 61.

<6. Arrangement of Photo Sensors>

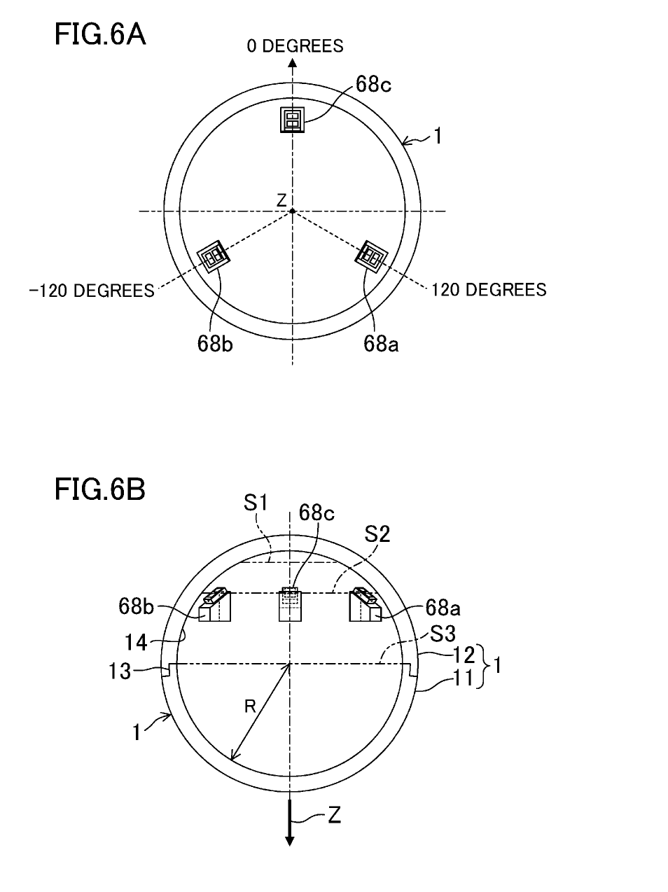

FIGS. 6A and 6B illustrate an arrangement of the photo sensors 68 in the outer shell 1. FIG. 6A is a view of the photo sensors 68 from the back in an optical axis direction, and FIG. 6B is a view of the photo sensors 68 in a direction perpendicular to the optical axis direction. The photo sensors 68 are provided on the surface (i.e., a back surface) of the circuit board 28 opposite to the movable frame 21. The photo sensors 68 are arranged about the Z axis at about every 120°, and the circumferential positions of the photo sensors 68 about the Z axis are substantially coincident respectively with the first to third drivers 26A-26C. For the sake of simplicity of description, the photo sensor 68 corresponding to the first driver 26A is referred to as a “first photo sensor 68a,” the photo sensor 68 corresponding to the second driver 26B is referred to as a “second photo sensor 68b,” and the photo sensor 68 corresponding to the third driver 26C is referred to as a “third photo sensor 68c.” Note that, if the photo sensors 68 are described without distinction, the photo sensor(s) 68 is simply referred to as a “photo sensor(s) 68.” The angular position of the first photo sensor 68a is 120°, and the angular position of the second photo sensor 68b is −120°, supposing that the angular position of the third photo sensor 68c about the Z axis is 0°.

<7. Configuration of Reflective Film>

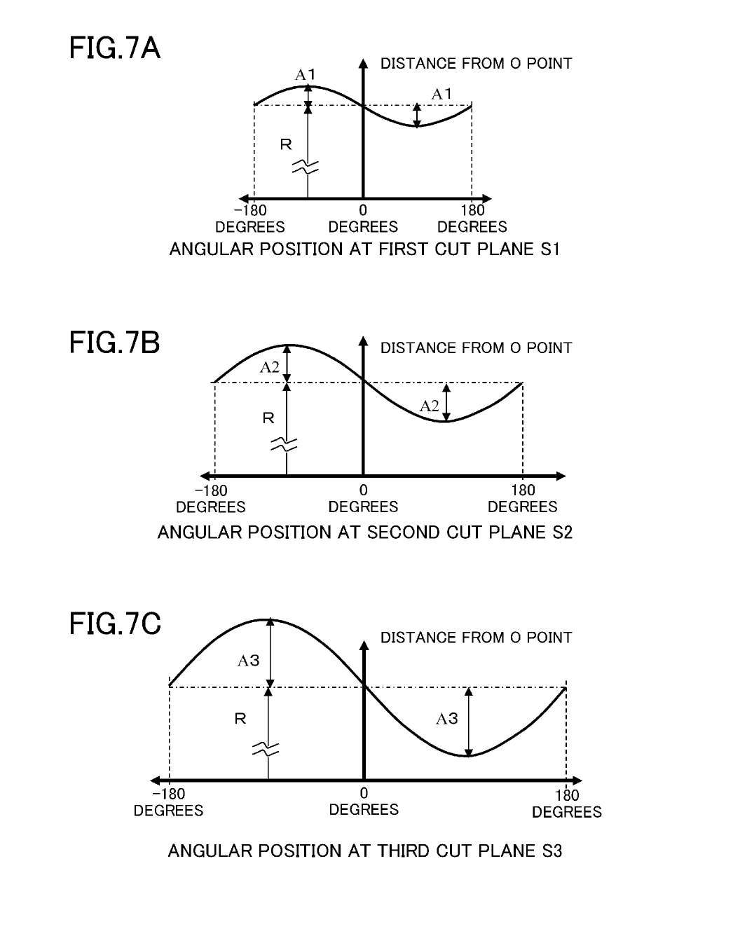

The reflective film 14 is in an undulant shape. Specifically, the cross-sectional shape of the outer shell 1 along a plane substantially forms a circle. In a circle of the outer shell 1 formed by cutting the outer shell 1 along a plane parallel to the joint part 13, the distance (hereinafter simply referred to as a “distance to the reflective film 14”) from the center O of the outer shell 1 to a surface of the reflective film 14 sinusoidally changes along the circle. Moreover, an amplitude upon the sinusoidal change varies depending on the distance between the joint part 13 and the cut plane. An example is illustrated in FIGS. 7A, 7B, and 7C. FIGS. 7A, 7B, and 7C are graphs each showing the distance from the center O of the outer shell 1 to the surface of the reflective film 14. FIG. 7A is the graph for a first cut plane 51 which is coincident with the joint part 13. FIG. 7B is the graph for a second cut plane S2 which is apart from the joint part 13 by a first distance. FIG. 7C is the graph for a third cut plane S3 which is apart from the joint part 13 by a second distance longer than the first distance. Note that the second cut plane S2 is a plane including the three photo sensors 68 when the camera body 2 is in the reference state.

In any one of the cut planes parallel to the joint part 13, the distance to the reflective film 14 sinusoidally changes such that one circle includes one sine wave, providing a reference radius R as a reference distance. For example, the reference radius R is an average of the distance to the reflective film 14. Moreover, the phase of a sinusoidal wave is the same in all of the cut planes. Note that a circumferential length decreases with distance from the joint part 13, and therefore the cycle itself is shortened. In addition, the amplitude of the sinusoidal wave decreases with distance from the joint part 13. That is, A1>A2>A3 is satisfied, where “A1” represents the amplitude at the first cut plane S1, “A2” represents the amplitude at the second cut plane S2, and “A3” represents the amplitude at the third cut plane S3.

Note that the reflective film 14 on an inner circumferential surface of the first case 11 and the reflective film 14 on an inner circumferential surface of the second case 12 are symmetric with respect to the joint part 13.

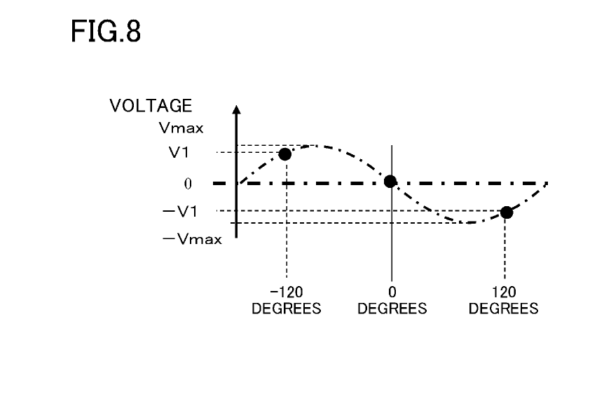

A longer distance to the reflective film 14 results in a greater voltage signal output from the photo sensor 68, whereas a shorter distance to the reflective film 14 results in a smaller voltage signal output from the photo sensor 68. Suppose that the photo sensor 68 is set so as to output voltage of 0 V when the distance to the reflective film 14 is the reference radius R. Referring to FIG. 8, if the third photo sensor 68c faces, at the second cut plane S2, the reflective film 14 such that the distance to the reflective film 14 is the reference radius R, an output of the third photo sensor 68c is 0 [V], an output of the first photo sensor 68a is −V₁ [V], and an output of the second photo sensor 68b is V₁ [V]. For example, when the camera body 2 rotates about the P axis of the outer shell 1 from such a state, each photo sensor 68 outputs sinusoidal voltage having the maximum amplitude V. [V] such that the phases of sinusoidal voltage from the photo sensors 68 are shifted from each other by 120°.

The position detector 60 detects, based on outputs of the photo sensors 68, the position of the camera body 2 in the outer shell 1, i.e., the inclination angle (hereinafter also referred to as the “direction of the optical axis 20 of the camera body 2”) of the camera body 2 with respect to the P axis of the outer shell 1.

In the position memory 69, outputs of the photo sensors 68 are successively stored together with an initial state in which the optical axis 20 of the camera body 2 points in a positive direction of the P axis of the outer shell 1 (i.e., points the first case 11). That is, the direction of the optical axis 20 of the camera body 2 is detectable based on outputs of the photo sensors 68 stored in the position memory 69. Although the reflective film 14 on the first case 11 and the reflective film 14 on the second case 12 are symmetric to each other, it can be, by successively storing outputs of the photo sensors 68, determined whether the optical axis 20 of the camera body 2 faces the first case 11 or the second case 12.

<8. Obstruction Removal Processing>

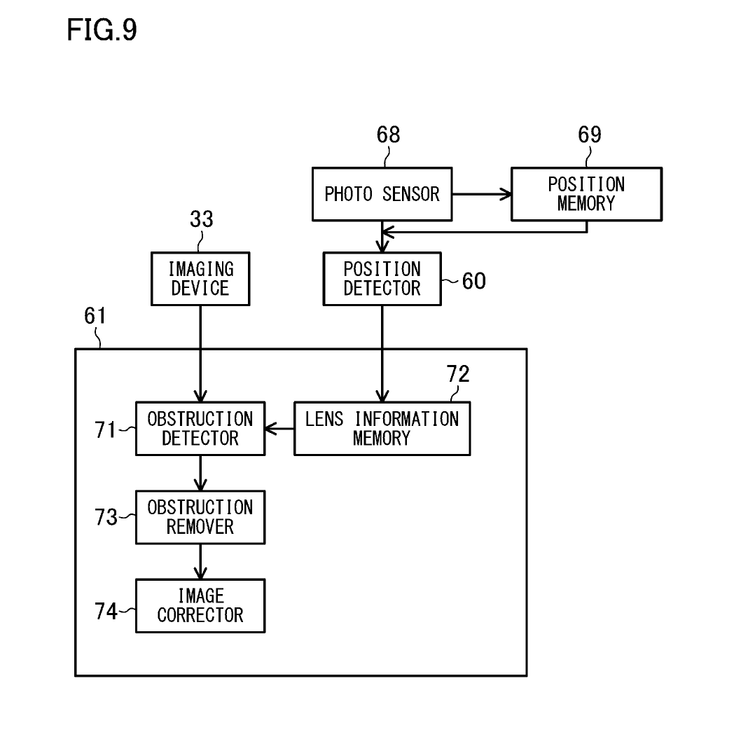

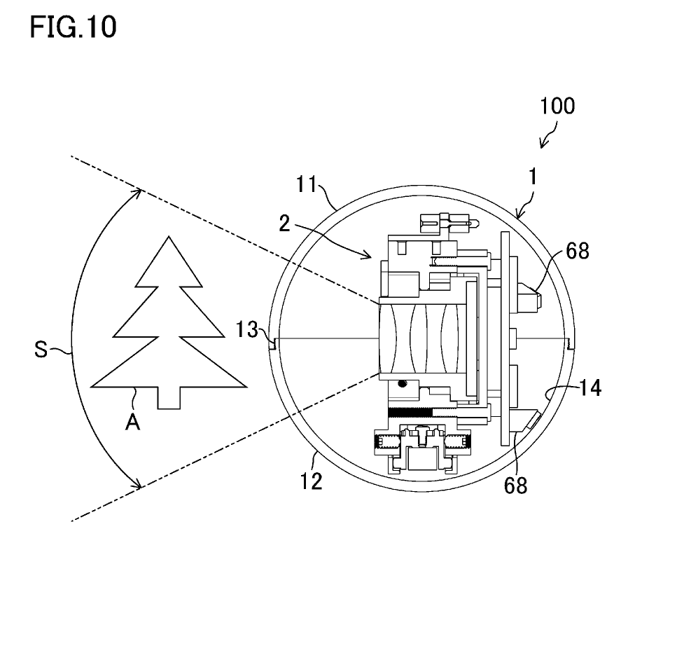

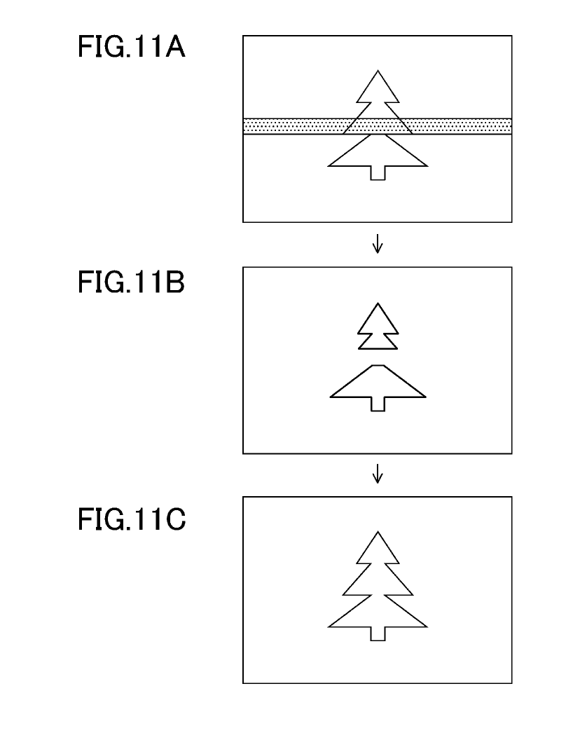

FIG. 9 is a functional block diagram illustrating a section provided in the image processor 61 and configured to perform obstruction removal processing. FIG. 10 is a view illustrating the situation in which the joint part 13 is within a shooting range S of the camera body 2 upon shooting of an image of an object A. FIGS. 11A, 11B, and 11C illustrate a shot image in the course of obstruction removal processing. For example, if an image is shot in the situation illustrated in FIG. 10, the shot image illustrated in FIG. 11A is acquired.

The image processor 61 includes an obstruction detector 71 configured to detect an obstruction from a shot image, a lens information memory 72 configured to store optical information on the lens barrel 3 and information on the joint part 13, an obstruction remover 73 configured to remove an image of the obstruction from the shot image, and an image corrector 74 configured to correct the shot image from which the obstruction is removed.

In the lens information memory 72, the following is stored: the distance from the imaging device 33 to the inner surface of the outer shell 1; the angle of view, the focal length, and an F-number of the lens barrel 3; and the color and transparency of the joint part 13. The direction of the optical axis 20 of the camera body 2 obtained by the position detector 60, the information stored in the lens information memory 72, and an output signal (i.e., the shot image) from the imaging device 33 are input to the obstruction detector 71. The obstruction detector 71 identifies, based on the direction of the optical axis 20 of the camera body 2 and the information stored in the lens information memory 72, the position and shape of an image of the joint part 13 in the shot image. That is, based on the position relationship between the outer shell 1 and the camera body 2, the position and shape of the image of the joint part 13 in the shot image can be identified.

Moreover, the obstruction detector 71 more accurately identifies the image of the joint part 13 in the shot image. Specifically, the obstruction detector 71 extracts an image part having brightness equal to or less than a predetermined value in a region of the shot image containing the identified image of the joint part 13, and then identifies such an image part as the image of the joint part 13. That is, the brightness in part of an object image shot through the joint part 13 is lowered. As in the foregoing, the obstruction detector 71 specifically identifies the image of the joint part 13 based not only on the position relationship between the outer shell 1 and the camera body 2 but also on the actual shot image. Since the image of the joint part 13 is identified using the actual shot image, the image of the joint part 13 can be more accurately identified even if there is an error in the position relationship between the joint part 13 and the reflective film 14 or in detection results of the photo sensors 68.

Note that the obstruction detector 71 may not identify the image of the joint part 13 based on the brightness, and may identify the image of the joint part 13 based on the position relationship between the outer shell 1 and the camera body 2. Subsequently, the obstruction remover 73 removes, referring to FIG. 11B, the image of the joint part 13 from the shot image of the imaging device 33.

Then, the image corrector 74 interpolates an image part from which the image of the joint part 13 is removed based on a surrounding image part, and corrects the shot image as illustrated in FIG. 11C.

As in the foregoing manner, the image processor 61 identifies the image of the joint part 13 from the shot image, and the shot image can be acquired with reduction in influence of the image of the joint part 13.

<9. Usage Example of Imaging Apparatus>

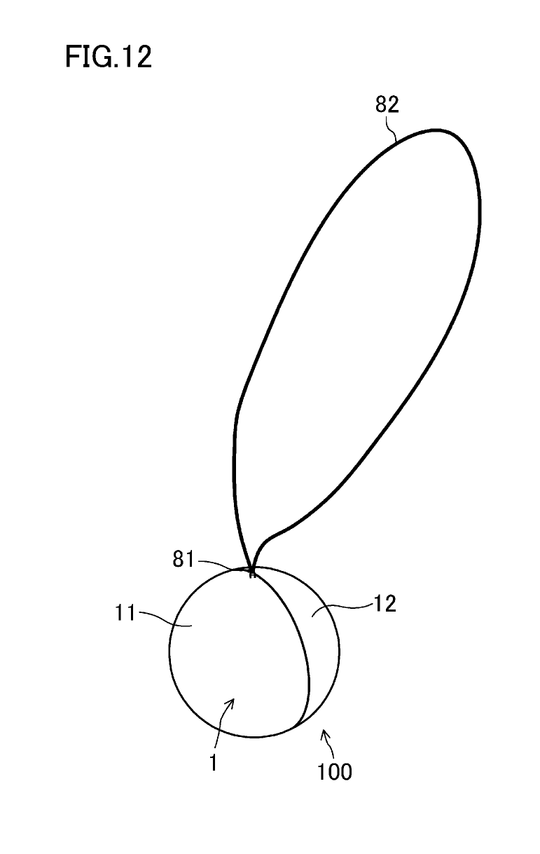

FIG. 12 illustrates a usage example of the imaging apparatus 100.

A pin 81 is provided on an outer surface of the first case 11. A strap 82 is attached to the pin 81. A hook-and-loop fastener (not shown in the figure) is provided on an outer surface of the second case 12.

A user wears the strap 82 around a neck, and uses the imaging apparatus 100 with the imaging apparatus 100 being hung from the neck. In such a state, the hook-and-loop fastener is attached to, e.g., clothes, thereby reducing or preventing large shaking of the imaging apparatus 100 during walking etc.

The camera body 2 can be operated in panning, tilting, and rolling directions by a wireless communication device such as a smart phone. Moreover, image blurring during walking can be reduced by the gyro sensor 67.

<10. Advantages>

Thus, the imaging apparatus 100 includes the outer shell 1, the camera body 2 configured to move in the outer shell 1 and shoot an image of an object outside the outer shell 1 through the outer shell 1, the obstruction detector 71 configured to detect an obstruction in or on the outer shell 1 from the image shot by the camera body 2, and the obstruction remover 73 configured to remove an image of the obstruction detected by the obstruction detector 71 from the shot image.

According to such a configuration, the imaging apparatus 100 can detect the obstruction in, on, or near the outer shell 1 to remove the image of the obstruction from the shot image. As a result, degradation of an image quality due to the obstruction in, on, or near the outer shell 1 can be reduced.

The imaging apparatus 100 further includes the position detector 60 configured to detect the position of the camera body 2 in the outer shell 1. The outer shell 1 is formed such that a plurality of parts are joined together at the joint part 13. Based on the position of the camera body 2 detected by the position detector 60, the obstruction detector 71 detects, as the obstruction, the joint part 13 from the shot image.

According to such a configuration, the position detector 60 detects the position of the camera body 2 in the outer shell 1, and therefore the position and shape of the image of the joint part 13 in the shot image can be identified.

<11. Variation>

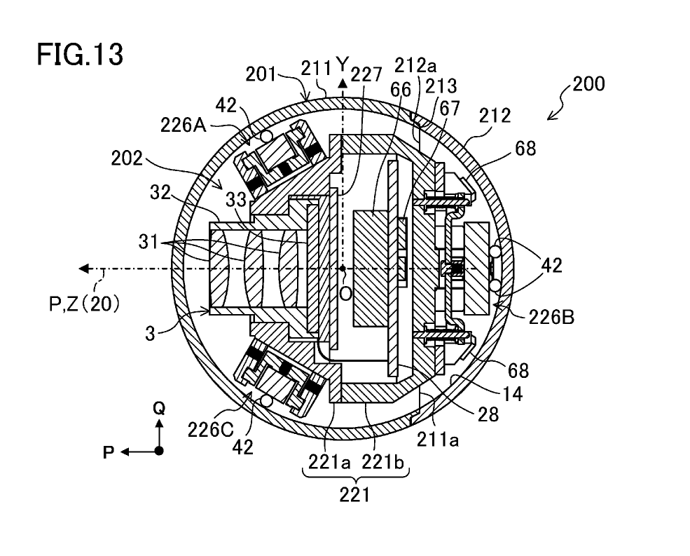

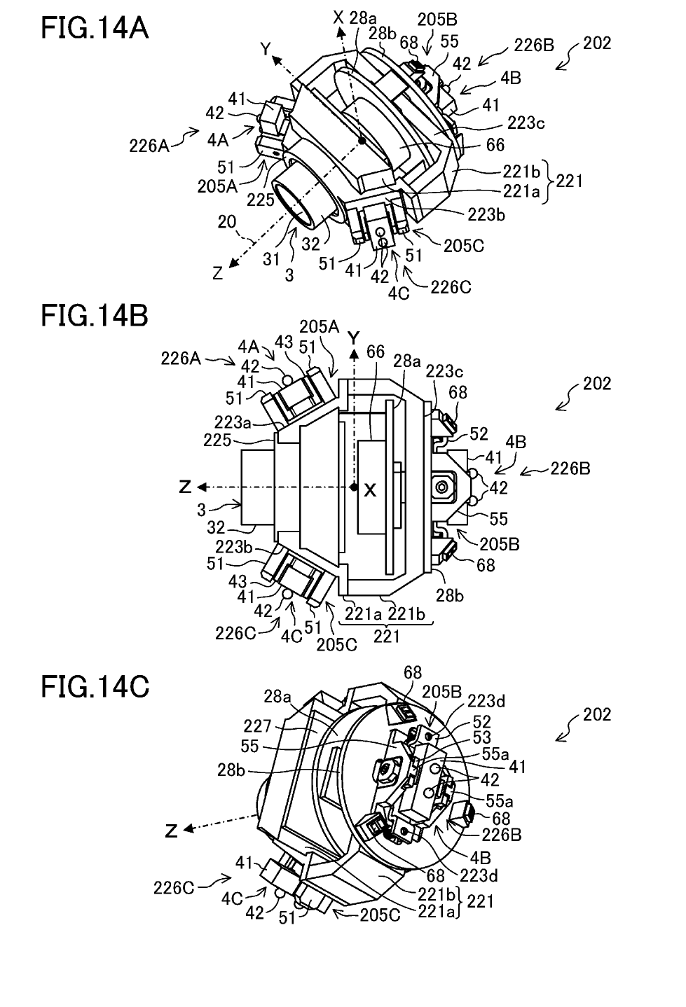

Next, a variation will be described. The camera body 2 is not limited to the foregoing configuration, and may have any configurations. FIG. 13 is a cross-sectional view of an imaging apparatus 200 of the variation. FIGS. 14A, 14B, and 14C illustrate a camera body 202 of the variation. FIG. 14A is a perspective view of the camera body 202. FIG. 14B is a right side view of the camera body 202. FIG. 14C is a perspective view of the camera body 202 from an angle different from that of FIG. 14A.

Specifically, an outer shell 201 includes a first case 211 and a second case 212. The outer shell 201 is formed so as to have a substantially spherical inner surface. The outer shell 201 is one example of a case.

The first case 211 is formed in a spherical-sector shape so as to have the great circle of the outer shell 201. The second case 212 is formed in a spherical-sector shape so as not to have the great circle of the outer shell 201. The first case 211 and the second case 212 are joined together at an opening 211a and an opening 212a. In such a manner, the outer shell 201 having a joint part 213 is formed. A reflective film 14 is formed on the inner surface of the outer shell 201.

The camera body 202 includes a movable frame 221, a lens barrel 3, first to third drivers 226A-226C attached to the movable frame 221, an attachment plate 227 configured to attach the lens barrel 3 to the movable frame 221, and a circuit board 28 configured to control the camera body 202. The camera body 202 can shoot still images and moving pictures. An optical axis 20 of the lens barrel 3 is referred to as a “Z axis,” and a side close to an object relative to the optical axis 20 is referred to as a “front side.” The camera body 202 is one example of an imager.

The movable frame 221 includes a first frame 221a and a second frame 221b. The first frame 221a and the second frame 221b are fixed together with screws. The first frame 221a includes a first side wall 223a to which the first driver 226A is attached, a second side wall 223b to which the third driver 226C is attached, and a cylindrical part 225 in which the lens barrel 3 is arranged. The axis of the cylindrical part 225 is coincident with the Z axis. The first side wall 223a and the second side wall 223b are parallel to an X axis perpendicular to the Z axis, and are inclined to the Z axis. Specifically, the Z axis is a bisector of an angle formed between a normal of an outer surface of the first side wall 223a and a normal of an outer surface of the second side wall 223b. The second frame 221b includes a third side wall 223c to which the second driver 226B is attached. The third side wall 223c is perpendicular to the Z axis.

Note that an axis perpendicular to both of the Z and X axes is referred to as a “Y axis.”

The lens barrel 3 has the same configuration as that of the foregoing embodiment. The lens frame 32 is arranged in the cylindrical part 225 of the movable frame 221, and the optical axis 20 is coincident with the axis of the cylindrical part 225. The attachment plate 227 is provided on a back side of the imaging device 33 of the lens barrel 3. The lens barrel 3 is attached to the movable frame 221 through the attachment plate 227.

The first to third drivers 226A-226C are provided on an outer circumferential surface of the movable frame 221. Specifically, the first driver 226A is provided on the first side wall 223a. The second driver 226B is provided on the third side wall 223c. The third driver 226C is provided on the second side wall 223b. The first to third drivers 226A-226C are arranged about the X axis at substantially equal intervals, i.e., at about every 120°.

The first driver 226A includes an actuator body 4A and a first support mechanism 205A. The second driver 226B includes an actuator body 4B and a second support mechanism 205B. The third driver 226C includes an actuator body 4C and a third support mechanism 205C.

The actuator bodies 4A-4C have the same configuration. The actuator bodies 4A-4C have the same configuration as that of the foregoing embodiment.

A basic configuration of the first support mechanism 205A is the same as that of the first support mechanism 5A. The first support mechanism 205A and the first support mechanism 5A are different from each other in the attitude of the actuator body 4A. Specifically, the actuator body 4A is supported by the first support mechanism 205A so as to rotate about an axis which is contained in a plane including the Y and Z axes and which is inclined to the Z axis. In such a state, two driver elements 42 of the actuator body 4A are arranged parallel to the X axis.

A basic configuration of the third support mechanism 205C is the same as that of the second support mechanism 5B. The third support mechanism 205C and the second support mechanism 5B are different from each other in the attitude of the actuator body 4C (actuator body 4B). Specifically, the actuator body 4C is supported by the third support mechanism 205C so as to rotate about an axis which is contained in the plane including the Y and Z axes and which is inclined to the Z axis. In such a state, two driver elements 42 of the actuator body 4C are arranged parallel to the X axis.

A basic configuration of the second support mechanism 205B is the same as that of the third support mechanism 5C. The second support mechanism 205B and the third support mechanism 5C are different from each other in the attitude of the actuator body 4B (actuator body 4C). Specifically, the actuator body 4B is supported by the second support mechanism 205B so as to move in a Z-axis direction and to rotate about a rotary shaft 44. In such a state, two driver elements 42 of the actuator body 4B are arranged parallel to the Y axis.

When drive voltage is applied to the first to third drivers 226A-226C, elliptic motion of each of the driver elements 42 of the first to third drivers 226A-226C is generated. Upon the elliptic motion of the driver elements 42, the first driver 226A outputs drive force in a circumferential direction about the Z axis. The third driver 226C outputs drive force in the circumferential direction about the Z axis. The second driver 226B outputs drive force in a circumferential direction about the X axis. Thus, the drive force of the first driver 226A and the drive force of the third driver 226C can be combined together, thereby rotating the camera body 202 about the Y axis or the Z axis. Moreover, the camera body 202 can rotate about the X axis by the drive force of the second driver 226B. As in the foregoing, in such a manner that the drive force of the first to third drivers 226A-226C is adjusted, the camera body 202 can rotationally move relative to the outer shell 201, and the attitude of the camera body 202 on the outer shell 201 can be arbitrarily adjusted.

The circuit board 28 is divided into a first board 28a and a second board 28b. An image processor 61, a drive controller 62, an antenna 63, a transmitter 64, a receiver 65, a battery 66, and a gyro sensor 67 are provided on the first board 28a. Photo sensors 68 are provided on the second board 28b. The photo sensors 68 are provided on a surface of the second board 28b opposite to the first board 28a. The first board 28a and the second board 28b are attached to the second frame 221b so as to sandwich the third side wall 223c. The first board 28a is positioned inside the movable frame 21, and the second board 28b is positioned outside the movable frame 21.

In the imaging apparatus 200 configured as described above, the position of the camera body 202 with respect to the outer shell 201 is also detectable based on outputs of the photo sensors 68. As a result, an image of the joint part 213 can be removed from a shot image, and the shot image can be corrected.

### Second Embodiment

Next, a second embodiment will be described.

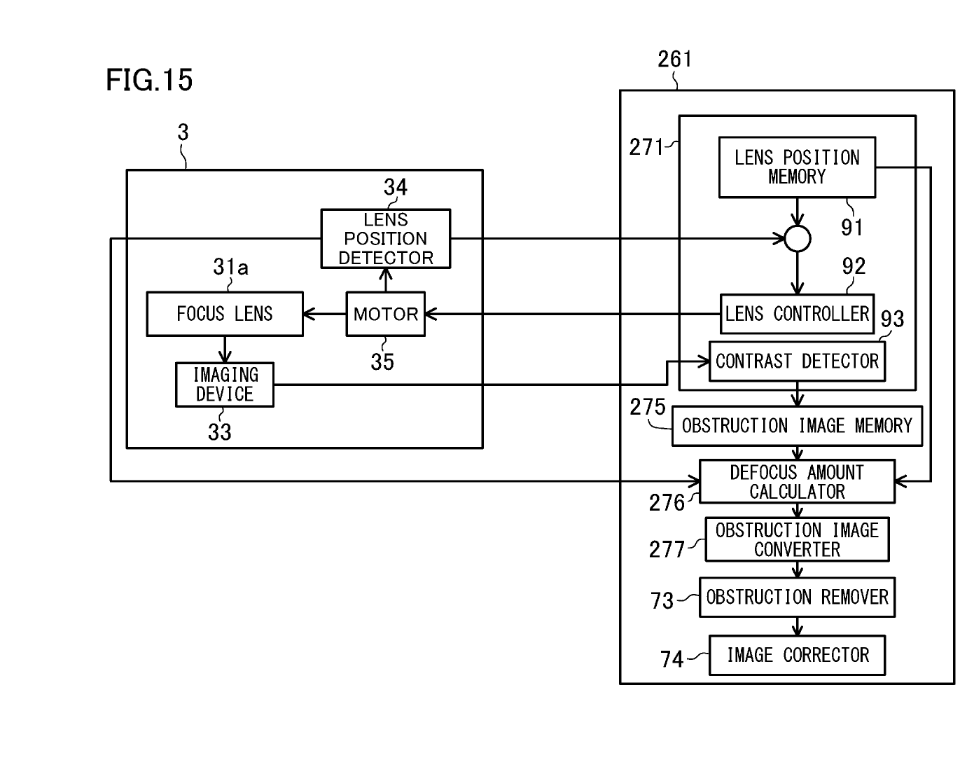

An imaging apparatus of the second embodiment is different from that of the first embodiment in a method for detecting an obstruction in a shot image. The same reference numerals as those described in the configuration of the first embodiment are used to represent equivalent elements, and the description thereof will not be repeated. Different configurations will be mainly described. FIG. 15 is a functional block diagram of a lens barrel 3 and an image processor 261 of the second embodiment.

A basic function of the image processor 261 is the same as that of the image processor 61. The image processor 261 includes an obstruction detector 271 configured to detect an obstruction from a shot image, an obstruction image memory 275 configured to store information on the obstruction detected by the obstruction detector 271, a defocus amount calculator 276 configured to calculate a defocus amount, an image converter 277 configured to convert an obstruction image based on the calculated defocus amount, an obstruction remover 73 configured to remove an image of the obstruction from the shot image, and an image corrector 74 configured to correct the shot image from which the obstruction is removed.

The obstruction detector 271 is configured to detect the obstruction by using a given distance from an imaging device to an outer shell 1 (e.g., a joint part 13). The obstruction detector 271 includes a lens position memory 91 configured to store the position of a focus lens, a lens controller 92 configured to control driving of the focus lens, and a contrast detector 93 configured to detect a contrast value for the shot image.

The lens barrel 3 further includes a focus lens 31a configured to adjust a focus state of an object, a lens position detector 34 configured to detect the position of the focus lens 31a in the lens barrel 3, and a stepping motor 35 configured to drive the focus lens 31a. The lens position detector 34 is, e.g., a transmissive photointerrupter (not shown in the figure), and includes an original point detecting unit configured to detect the focus lens 31a positioned at an original point. The lens position detector 34 detects the position of the focus lens 31a based on the drive amount of the stepping motor 35 from the state in which the focus lens 31a is positioned at the original point.

In the lens position memory 91, e.g., information on the position of the focus lens 31a in the lens barrel 3 when an image of the outer shell 1 is formed on the imaging device 33 is stored.

Based on the position information of the focus lens 31a from the lens position detector 34 and the position information from the lens position memory 91, the lens controller 92 operates the stepping motor 35 such that the focus lens 31a moves to the position at which the image of the outer shell 1 is formed on the imaging device 33. In such a manner, shooting is performed with the outer shell 1 being focused. An image acquired by such shooting is a reference image. The contrast detector 93 extracts image information corresponding to the highest contrast part of the reference image, and determines the extracted image information as the obstruction (e.g., the joint part 13). Note that the contrast detector 93 may determine, as the obstruction, image information corresponding to part of the reference image having contrast of equal to or greater than a predetermined value. Alternatively, the contrast detector 93 may determine, as the obstruction, image information corresponding to the highest contrast part of the reference image having contrast of equal to or greater than a predetermined value. That is, even if the contrast is the highest in the reference image, but has contrast smaller than the predetermined value, such information is not determined as the obstruction.

The obstruction detector 271 causes the obstruction image memory 275 to store the image information extracted as the obstruction.

Then, the lens controller 92 moves the focus lens 31a to the position at which an object targeted for shooting is focused. Based on the position information of the focus lens 31a from the lens position detector 34 and the position information from the lens position memory 91, the defocus amount calculator 276 calculates a difference between the position of the focus lens 31a when the object targeted for shooting is focused and the position of the focus lens 31a when the outer shell 1 (i.e., the obstruction) is focused. Such a difference corresponds to the defocus amount of the obstruction when the focus lens 31a is at such a position that the object targeted for shooting is focused. The image converter 277 converts the obstruction image stored in the obstruction image memory 275 into an image blurred in such a manner that a focal point is shifted by the defocus amount calculated by the defocus amount calculator 276.

The obstruction remover 73 and the image corrector 74 perform processing similar to that of the first embodiment. That is, the obstruction remover 73 removes the obstruction image converted by the image converter 277 from the shot image, and the image corrector 74 interpolates the image part from which the obstruction image is removed based on a surrounding image part. As in the foregoing, the image processor 261 identifies the image of the joint part 13 from the shot image, and the shot image can be acquired with reduction in influence of the image of the joint part 13.

Thus, in the imaging apparatus 100 of the second embodiment, the camera body 2 is configured to perform shooting with the outer shell 1 being focused to acquire the reference image, and the obstruction detector 271 detects the obstruction based on the reference image. That is, the imaging apparatus 100 performs shooting with the outer shell 1 being focused. In such a state, if a high contrast image is contained in the shot image, the imaging apparatus 100 determines the high contrast image as the obstruction, and removes the obstruction from the shot image in the state in which the object targeted for shooting is focused.

According to the foregoing, even if an obstruction in, on, or near the outer shell 1 is not, e.g., the joint part 13 having the given position and shape, such an obstruction can be detected and removed from a shot image.

Note that removal of an image of an obstruction is not limited to the foregoing method. For example, an image of an obstruction shot with the outer shell 1 being focused may be removed from a shot image without conversion into a more blurred image.

As described above, the foregoing embodiment has been described as example techniques disclosed in the present application. However, the techniques according to the present disclosure are not limited to the foregoing embodiment, but are also applicable to those where modifications, substitutions, additions, and omissions are made. In addition, elements described in the foregoing embodiment may be combined to provide a different embodiment. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

The foregoing embodiments may have the following configurations.

The imaging apparatuses 100, 200 shoot still images and moving pictures. However, the imaging apparatuses 100, 200 may shoot only still images or moving pictures.

The outer shells 1, 201 each have a double structure of the first case 11 and the second case 12, but are not limited to such a configuration. For example, the outer shell 1 may be divided into three or more parts.

The first to third drivers 26A-26C, 226A-226C are vibration actuators each including a piezoelectric device, but are not limited to such actuators. For example, the driver may include a stepping motor and a drive wheel, and may be configured such that the drive wheel contacts the inner surface of the outer shell 1.

The first to third drivers 26A-26C are arranged about the Z axis at equal intervals, but are not necessarily arranged at equal intervals. Moreover, the first to third drivers 226A-226C are arranged about the X axis at equal intervals, but are not necessarily arranged at equal intervals. Further, the number of drivers is not limited to three, and may be two or less or four or more. For example, if the imaging apparatus 100 includes four drivers, the four drivers may be arranged at equal intervals (i.e., at every 90°).

In the foregoing embodiments, the position of the camera body 2, 202 is detected by the photo sensors 68, but the present disclosure is not limited to such a configuration. For example, the position of the camera body 2, 202 may be detected by a magnet and a hall sensor, or may be detected in such a manner that the second case 12, 212 made of metal is used to detect eddy-current loss or an electrostatic capacitance change. Image detection of the first case 11, 211 by the camera body 2, 202 may be used.

The shape of the reflective film 14 of the first embodiment is one example. As long as the position of the camera body 2 with respect to the outer shell 1, 201 is detectable, the reflective film 14 can be in any shapes. For example, the reflective film 14 is formed such that the distance from the center O of the outer shell 1 sinusoidally changes at the cut plane parallel to the joint part 13 in the foregoing embodiments. However, the cut plane along which the reflective film 14 is cut such that the distance from the center O of the outer shell 1 sinusoidally changes is not necessarily parallel to the joint part 13. Moreover, the reflective film 14 on the first case 11 and the reflective film 14 on the second case 12 may be asymmetric to each other.

The method for detecting an obstruction in, on, or near the outer shell 1, 201 is not limited to those of the first and second embodiments. As long as an obstruction is detectable, any methods can be employed.

The method for removing an obstruction from a shot image and correcting the shot image is not limited to those of the first and second embodiments. As long as an influence of an obstruction on a shot image can be reduced, any correction methods can be employed. In the first and second embodiments, image information corresponding to an obstruction is removed, and then a removed image part is interpolated based on a surrounding image part. However, image information corresponding to an obstruction may be used and corrected.

As described above, the technique disclosed herein is useful for the imaging apparatus including the imager arranged inside the case having the spherical inner surface.

What is claimed is:

1. An imaging apparatus for shooting an object image, comprising:
a case;
an imager configured to move in the case and shoot an image of an object outside the case through the case;
an obstruction detector configured to detect an obstruction in or on the case from the image shot by the imager; and
an image processor configured to remove an image of the obstruction detected by the obstruction detector from the image shot by the imager.

2. The imaging apparatus of claim 1, further comprising:
a position detector configured to detect a position of the imager in the case,
wherein the case is formed such that a plurality of parts are joined together at a joint part, and
based on the position of the imager detected by the position detector, the obstruction detector detects, as the obstruction, the joint part from the image shot by the imager.

3. The imaging apparatus of claim 2, further comprising:
at least three measurers configured to measure a distance between the imager and the case,
wherein the position detector detects the position of the imager in the case based on measurement results of the at least three measurers.

4. The imaging apparatus of claim 1, wherein
the imager is configured to perform shooting with the case being focused to acquire a reference image, and
the obstruction detector detects the obstruction based on the reference image.
